(19) United States
(12) Patent Application Publication
(10) Pub. No.: US 2025/0389382 A1
(43) Pub. Date: Dec. 25, 2025

(54) FIXING HOLDER

(71) Applicant: WODE GLOBAL (QINGDAO) OUTDOOR CO., LTD., Qingdao City (CN)

(72) Inventor: Yingchun ZHAO, Qingdao City (CN)

(21) Appl. No.: 19/243,653

(22) Filed: Jun. 19, 2025

(30) Foreign Application Priority Data
Jun. 20, 2024 (CN) 202421420461.X
Mar. 29, 2025 (CN) 202520572630.X

(51) Int. Cl. F16M 13/02; B60R 9/10; F16B 2/08; F16B 2/10

(52) U.S. Cl. CPC F16M 13/022; F16B 2/08; F16B 2/10; B60R 9/10; F16M 2200/06

(57) ABSTRACT

The present application relates to the technical field of holder connections, and in particular, to a fixing holder. A binding assembly includes a ratchet fastening block, an inner plug is arranged at one end of a cantilever tube, a recess is formed in an end portion of the inner plug, the cantilever tube is inserted into the ratchet fastening block, and a protrusion connected with the recess in an engaged manner is arranged on the ratchet fastening block. A convex clamp jaw of a clamping assembly is fixed at one end portion of the cantilever tube, a screw mandrel connected with the cantilever tube extends from the convex clamp jaw, an oblique web inclined upwards is arranged in an inner cavity of a concave clamp jaw, a T-shaped nut is in threaded connection to an end portion of the screw mandrel, and a lower end of a transverse flange at an end portion of the T-shaped nut transversely and directly faces an inclined surface of the oblique web. The present application has the beneficial effect that opening/closing and clamping action of the clamping assembly can be realized only by controlling rotation of the screw mandrel, thus greatly improving operation convenience.

### CROSS-REFERENCE TO RELATED APPLICATIONS

The present application claims the priority of Chinese application No. 202520572630.X, filed on Mar. 29, 2025, and Chinese application No. 202421420461.X, filed on Jun. 20, 2024, the entire contents of which are incorporated herein by reference.

### TECHNICAL FIELD

The present application relates to the technical field of holder connections, and in particular, to a fixing holder.

### BACKGROUND

A holder, functioning as a connector for joining a pair of structural members, finds a most commonly used scenario of binding and fixing in transportation of frame type apparatuses, such as bicycles and scaffolds, and joints at two ends of the holder are used to be connected with a fixing member and a transportation member respectively.

A prior patent No. CN112172685B, titled “Frame Holder”, discloses an apparatus for connecting two objects, in particular for fixing a bicycle frame to a bicycle carrier, comprising a base body defining a longitudinal axis; and a clamping device being arranged at an end region of the base body, in order to connect the base body to a first object, in particular to a yoke of the bicycle carrier, the clamping device comprising at least two clamping elements, which form a receptacle for the first object therebetween and are movable relative to each other between an releasing position and a clamping position, wherein in the releasing position, the clamping device can be attached to or removed from the first object, and in the clamping position, the clamping device engages around the first object in a fixed manner.

However, a clamping end of the existing holder is generally configured as a pair of clamping devices rotating relatively, a clamping purpose is achieved by fixing the relative rotation positions, but the current closing operation based on rotating generally requires manual assistance, as in the above patent, fixing is achieved by pressing of the pressure element, but after the fixing is released, the pair of clamping devices will be automatically separated, and a re-closing operation requires the manual assistance, so that automatic closing cannot be realized.

In the prior art, for the convenience of fixing of a bicycle during transportation, a fixing clamp is generally provided to hold the bicycle, thereby guaranteeing limiting and fixing of a large number of bicycles and avoiding shifting or shaking of the bicycles during the transportation.

The prior patent discloses a bundling device for clamping a bicycle by insertion between a toothed belt and a clamp plate, in which inclined directions of teeth of the toothed belt and the clamp plate are opposite so as to prevent the toothed belt from being automatically loosened.

However, the fixing clamp arrangement based on toothed belt binding is not provided with a fastening device, and fastening and clamping of the bicycle completely depend on traction of the toothed belt, so that the toothed belt extends through an upper end of the clamp plate in an existing clamping process, binding and fixing of the bicycle by the toothed belt can be realized only by applying a large pulling force to the toothed belt, adjustment of a clamping pretightening force is lacked, and looseness is quite easily caused during transportation.

### SUMMARY

An objective of the present application is to provide a fixing holder, to solve the problem raised in the Background above.

To achieve the above objective, in an aspect, the present application provides the following technical solution.

A fixing holder includes a cantilever tube, two ends of the cantilever tube being respectively provided with a clamping assembly, which effects clamping by oppositely closing a convex clamp jaw and a concave clamp jaw, and a binding assembly, which effects binding and connecting by means of a ratchet belt, the clamping assembly including the convex clamp jaw and the concave clamp jaw which implement a relative elastic rotation separation through cooperating of a pivot shaft and a torsional spring, the convex clamp jaw being fixed at one end portion of the cantilever tube, a screw mandrel connected with the cantilever tube extending from the convex clamp jaw, an oblique web inclined upwards being arranged in an inner cavity of the concave clamp jaw, a T-shaped nut being in threaded connection to an end portion of the screw mandrel, and a lower end of a transverse flange at an end portion of the T-shaped nut transversely and directly facing an inclined surface of the oblique web.

Preferably, the binding assembly includes a ratchet fastening block, an inner plug is arranged at one end of the cantilever tube, a recess is formed in an end portion of the inner plug, the cantilever tube is inserted into the ratchet fastening block, and a protrusion connected with the recess in an engaged manner is arranged on the ratchet fastening block.

Preferably, a loop bar and a locking assembly are arranged on the ratchet fastening block, one end of the ratchet belt is rotatably mounted on the loop bar, and the other end of the ratchet belt is fixed on the locking assembly.

Preferably, the locking assembly includes a lever meshed with a ratchet transmission on the ratchet belt and a key for controlling the lever to rotate relatively, and the ratchet fastening block is provided with a lock catch assembly for controlling the key to move.

Preferably, the convex clamp jaw and the concave clamp jaw are rotatably connected through the pivot shaft, the torsional springs for driving the convex clamp jaw and the concave clamp jaw to rotate and separate relatively are arranged at two ends of the pivot shaft, a welding seat is arranged in an inner cavity of an end of the cantilever tube close to the convex clamp jaw, the screw mandrel is fixed on the welding seat, and the screw mandrel penetrates through the convex clamp jaw to extend into an inner cavity between the convex clamp jaw and the concave clamp jaw.

Preferably, an end portion of the cantilever tube is provided with a tube plug, an end portion of the screw mandrel is provided with a mounting plate attached to the welding seat, and the tube plug and the mounting plate are fixed on the welding seat through fastening bolts.

Preferably, a threaded through hole is arranged through the T-shaped nut, the screw mandrel rotatably penetrates through the threaded through hole by threads, and the end portion of the screw mandrel is provided with a stop ring.

Preferably, a side of the transverse flange of the end portion of the T-shaped nut directly facing the oblique web is provided with a circular arc rounded surface.

Compared with the prior art, the prevent application achieves the following beneficial effects.

In the present application, by arranging the torsional spring(s), a relative elastic rotation separation of the convex clamp jaw and the concave clamp jaw is implemented so as to achieve a purpose of automatically releasing the clamping assembly. Meanwhile, through cooperating of the T-shaped nut and the screw mandrel, the T-shaped nut is driven to transversely move, and transverse pressing of the T-shaped nut against the oblique web effects a relative rotation closing of the convex clamp jaw and the concave clamp jaw, so as to achieve a fixing and clamping purpose, so that the opening/closing and clamping action of the clamping assembly can be realized just by controlling the rotation of the screw mandrel, thus greatly improving operation convenience.

Another objective of the present application is to provide a bicycle fixing clamp, to solve the problem raised in the Background above.

To achieve the above objective, in another aspect, the present application provides the following technical solution.

A bicycle fixing clamp includes a fixing clamp unit, one end of the fixing clamp unit being provided with a ratchet belt, the other end of the fixing clamp unit being provided with a first clamp plate, a first insert slot for allowing penetration and insertion of the ratchet belt being arranged between the first clamp plate and the fixing clamp unit, the first clamp plate being provided with a rack having a tooth inclination direction opposite to a tooth inclination direction of the ratchet belt, a second clamp plate located at a lower end of the first clamp plate being arranged on the fixing clamp unit, the second clamp plate being rotatably mounted on the fixing clamp unit through an elastic torsional spring, one end of the second clamp plate extending to the lower end of the first clamp plate, the other end of the second clamp plate extending to a rear side of the rack, an end portion of the second clamp plate being provided with a plurality of groups of push teeth, and an inclination direction of the push teeth being the same as the tooth inclination direction of the rack.

Preferably, the first clamp plate is provided with a limiting block, a pressing frame with an adjustable height is arranged in an inner cavity of the fixing clamp unit, and a lower end of the pressing frame is pressed on an upper end of the limiting block.

Preferably, the fixing clamp unit is provided with a lock catch, the other end of the lock catch extends into the inner cavity of the fixing clamp unit and is rotatably connected with a cam, and the cam is pressed on the pressing frame.

Preferably, one side of the fixing clamp unit is provided with a pair of clamping hoofs which are symmetrically distributed, the pair of clamping hoofs define a clamping inner cavity, and an inner diameter/width of the clamping inner cavity is adjusted by the clamping hoof through a tightening device.

Preferably, a lower end of the fixing clamp unit is provided with a pivot shaft, and the second clamp plate is rotatably mounted on the pivot shaft through the elastic torsional spring.

Preferably, a positioning block located at the lower end of the first clamp plate is arranged on the fixing clamp unit, and a connecting frame inserted in the positioning block is arranged at the other end of the elastic torsional spring. Preferably, at least two groups of push teeth are provided.

Preferably, a second insert slot is arranged between the second clamp plate and the first clamp plate.

Compared with the prior art, the prevent application achieves the following beneficial effects.

In the present application, the second clamp plate which is rotatably mounted is arranged at the lower end of the existing fixing clamp unit, and the push teeth at the end portion of the second clamp plate are meshed with the ratchet belt extending to an outer side of the first clamp plate by rotation of the second clamp plate, so that the push teeth are driven by the rotation of the second clamp plate to pull the ratchet belt to be further stretched, and therefore, a clamping force is adjusted under an available adjustment size of a tooth clearance, so as to achieve a pre-tightening clamping purpose, thus improving clamping stability.

### BRIEF DESCRIPTION OF THE DRAWINGS

FIG. 1 is a schematic view of a three-dimensional structure according to an embodiment of the present application;

FIG. 2 is a schematic view of a three-dimensional structure of assembly of a T-shaped nut and an oblique web according to the present application;

FIG. 3 is an exploded view of the three-dimensional structure according to the present application;

FIG. 4 is a sectional view of the oblique web in a concave clamp jaw according to the present application;

FIG. 5 is a side view of a ratchet fastening block according to the present application;

FIG. 6 is a schematic view of a three-dimensional structure of an inner plug according to the present application;

FIG. 7 is a schematic view of the three-dimensional structure according to another embodiment of the present application;

FIG. 8 is a schematic view of a structure according to the present application;

FIG. 9 is a schematic view of a three-dimensional structure of mounting of a first clamp plate and a second clamp plate according to the present application;

FIG. 10 is a schematic view of a cam mounting structure according to the present application;

FIG. 11 is a schematic view of a limiting mounting structure of the first clamp plate according to the present application;

FIG. 12 is a schematic view of a three-dimensional structure of assembly of the cam and a pressing frame according to the present application; and

FIG. 13 is a schematic view of a three-dimensional structure of the second clamp plate according to the present application.

In the drawings:
1: ratchet fastening block; 2: ratchet belt; 3: locking assembly; 4: lock catch assembly; 5: cantilever tube; 6: convex clamp jaw; 7: pivot shaft; 8: concave clamp jaw; 9: welding seat; 10: tube plug; 11: screw mandrel; 12: T-shaped nut; 13: torsional spring; 14: inner plug; 15: mounting plate; 16: stop ring; 17: oblique web; 18: protrusion; 19: recess; 20: fastening bolt; 21: threaded through hole. 101: fixing clamp unit; 102: clamping hoof; 103: tightening device; 104: first clamp plate; 105: ratchet belt; 106: lock catch; 107: first insert slot; 108: second clamp plate; 109: cam; 110: pressing frame; 111: pivot shaft; 112: push tooth; 113: connecting frame; 114: limiting block; 116: second insert slot; 117: elastic torsional spring; 118: positioning block.

### DETAILED DESCRIPTION

The technical solutions according to the embodiments of the present application will be described clearly and completely below with reference to the accompanying drawings according to the embodiments of the present application. Apparently, the described embodiments are merely some of rather than all of the implementations of the present application. All other embodiments acquired by those of ordinary skill in the art without creative efforts based on the embodiments of the present disclosure shall fall within the protection scope of the application.

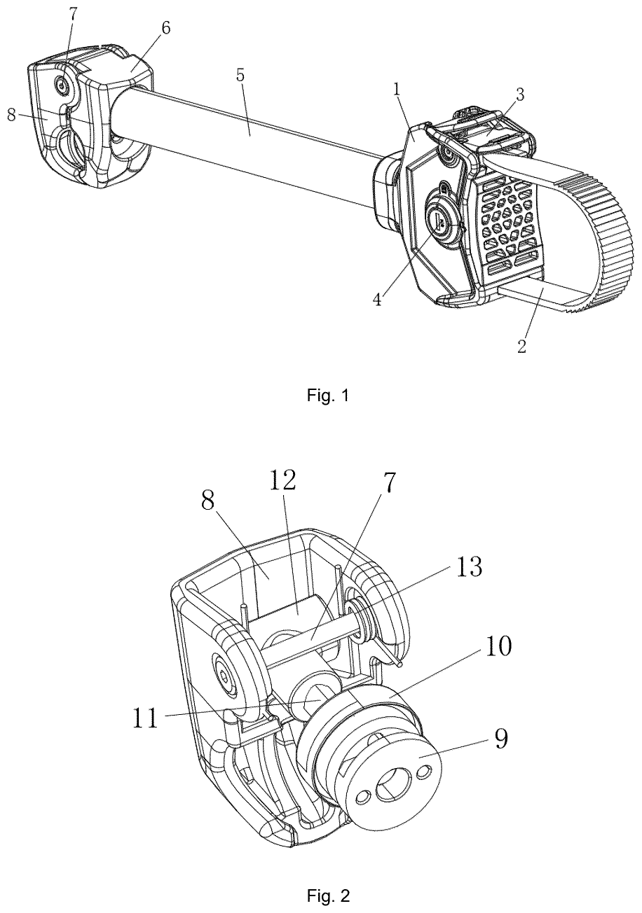

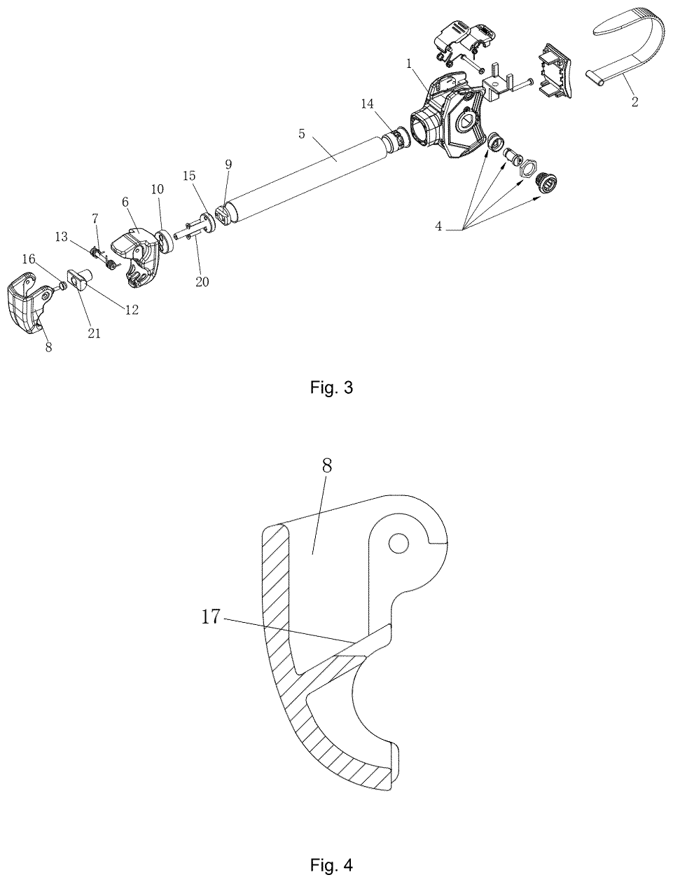

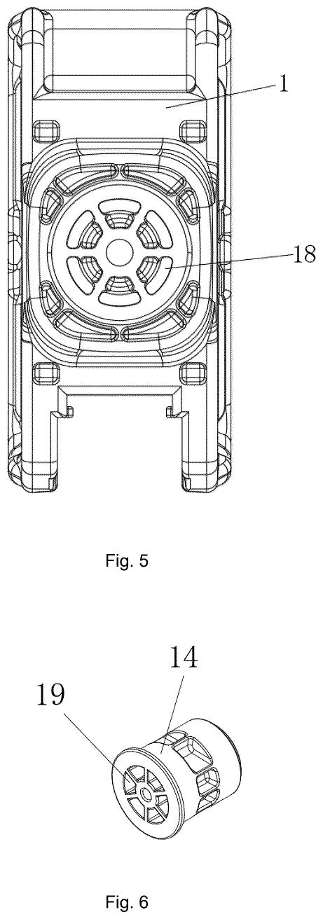

Referring to FIG. 1 to FIG. 6, the present application provides the following technical solution.

A fixing holder includes a cantilever tube 5, two ends of the cantilever tube 5 being respectively provided with a clamping assembly, which performs clamping action by oppositely closing a convex clamp jaw 6 and a concave clamp jaw 8, and a binding assembly, which performs binding and connecting action by means of a ratchet belt 2, wherein the binding assembly includes a ratchet fastening block 1, an inner plug 14 is arranged at one end of the cantilever tube 5, a recess 19 is formed in an end portion of the inner plug 14, the cantilever tube 5 is inserted into the ratchet fastening block 1, a protrusion 18 connected with the recess 19 in an engaged manner is arranged on the ratchet fastening block 1, a loop bar and a locking assembly 3 are arranged on the ratchet fastening block 1, one end of the ratchet belt 2 is rotatably mounted on the loop bar, and the other end of the ratchet belt 2 is fixed on the locking assembly 3; the locking assembly 3 includes a lever meshed with a ratchet transmission on the ratchet belt 2 and a key for controlling the lever to rotate relatively, and the ratchet fastening block 1 is provided with a lock catch assembly 4 for controlling the key to move.

Through the engaged connection of the recess 19 and the protrusion 18, the inner plug 14 is connected with the ratchet fastening block 1 and the cantilever tube 5, so that the ratchet fastening block 1 can be rotated to drive the cantilever tube 5 to rotate. Meanwhile, the ratchet belt 2 is inserted and latched on the locking assembly 3, and a position of the ratchet belt 2 is fixed through cooperating of the lever and the ratchet wheel mechanism, so as to achieve a purpose of binding and connecting of one end of the fixing holder. An angle of the lever is controlled by a button to control opening and closing of the ratchet belt 2. The key is limited by arranging the lock catch assembly 4, so as to avoid random opening and closing.

The arrangement, configuration and structure of the lock catch assembly 4 and the locking assembly 3 will be described in detail below.

The clamping assembly includes the convex clamp jaw 6 and the concave clamp jaw 8 which implement a relative elastic rotation separation through cooperating of a pivot shaft 7 and a torsional spring 13, the convex clamp jaw 6 and the concave clamp jaw 8 are rotatably connected through the pivot shaft 8, and the torsional springs 13 for driving the convex clamp jaw 6 and the concave clamp jaw 8 to rotate and separate relatively are arranged at two ends of the pivot shaft 7.

The relative rotation separation of the convex clamp jaw 6 and the concave clamp jaw 8 is achieved through the torsional spring 13, thereby facilitating a clamping operation, and automatic releasing can be realized under the action of the torsional spring 13.

The convex clamp jaw 6 is fixed at one end portion of the cantilever tube 5, a screw mandrel 11 connected with the cantilever tube 5 extends from the convex clamp jaw 6, a welding seat 9 is arranged in an inner cavity of an end of the cantilever tube 5 close to the convex clamp jaw 6, the screw mandrel 11 is fixed on the welding seat 9, the screw mandrel 11 penetrates through the convex clamp jaw 6 to extend into an inner cavity between the convex clamp jaw 6 and the concave clamp jaw 8, an end portion of the cantilever tube 5 is provided with a tube plug 10, an end portion of the screw mandrel 11 is provided with a mounting plate 15 attached to the welding seat 9, and the tube plug 10 and the mounting plate 15 are fixed on the welding seat 9 through fastening bolts 20.

The screw mandrel 11 and the convex clamp jaw 6 are mounted on the cantilever tube 5 through cooperating of the welding seat 9 and the fastening bolt 20.

An oblique web 17 inclined upwards is arranged in an inner cavity of the concave clamp jaw 8, a T-shaped nut 12 is in threaded connection to an end portion of the screw mandrel 11, and a lower end of a transverse flange at an end portion of the T-shaped nut 12 transversely and directly faces an inclined surface of the oblique web 17. A threaded through hole 21 is arranged through the T-shaped nut 12, the screw mandrel 11 rotatably penetrates through the threaded through hole 21 by threads, and the end portion of the screw mandrel 11 is provided with a stop ring 16. A side of the transverse flange of the end portion of the T-shaped nut 12 directly facing the oblique web 17 is provided with a circular arc rounded surface.

Transverse movement of the T-shaped nut 12 is achieved by utilizing the rotation of the end portion of the screw mandrel 11 in the threaded through hole 21, and transverse pressing of the T-shaped nut 12 against the oblique web 17 is further controlled to achieve a purpose of controlling the rotary clamping of the concave clamp jaw 8. The T-shaped nut 12 is prevented from falling off from the end portion of the screw mandrel 11 by arranging the stop ring 16. A pressing area is increased by configuring the circular arc rounded surface.

Working principle: under the action of the torsional spring 13, the convex clamp jaw 6 and the concave clamp jaw 8 rotate and separate relatively, so that the clamping assembly is kept in an open state initially to facilitate clamping and mounting; after mounting, the cantilever tube 5 is driven to rotate by rotating the ratchet fastening block 1, the cantilever tube 5 drives the screw mandrel 11 to rotate, and the transverse movement of the T-shaped nut 12 is achieved by utilizing the rotation of the end portion of the screw mandrel 11 in the threaded through hole 21.

When the T-shaped nut 12 presses the oblique web 17, the concave clamp jaw 8 is driven to rotate, and the concave clamp jaw 8 and the convex clamp jaw 6 are closed to achieve a stable clamping purpose.

When the T-shaped nut 12 is moved away from the oblique web 17, the convex clamp jaw 6 and the concave clamp jaw 8 are relatively separated by a reset elastic force of the torsional spring 13.

Specific implementations of the locking assembly 3 and the lock catch assembly 4 described above are exemplarily explained below with the aid of a fixing clamp unit including corresponding locking and lock catch mechanisms, the fixing clamp unit is particularly used for a bicycle fixing clamp, and the binding assembly of the fixing holder can be designed overall according to this configuration.

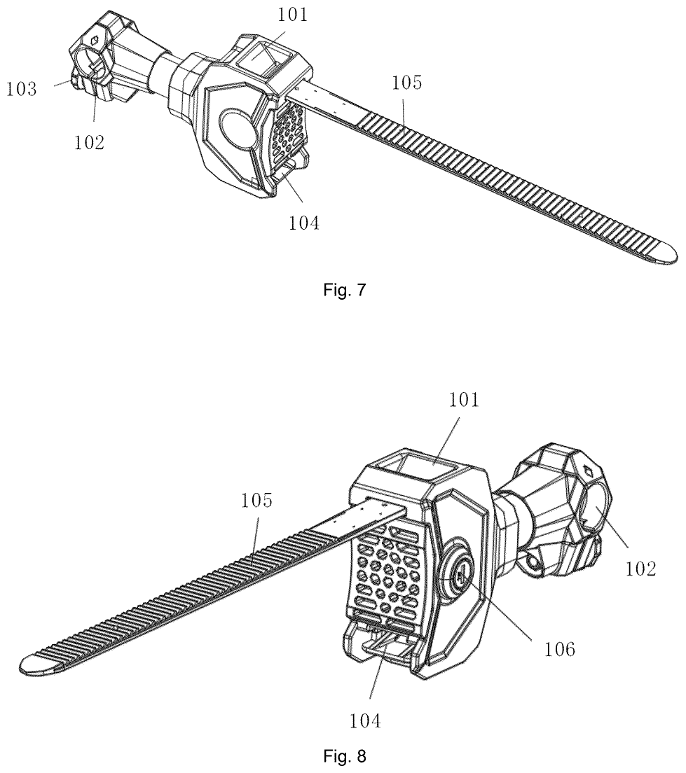

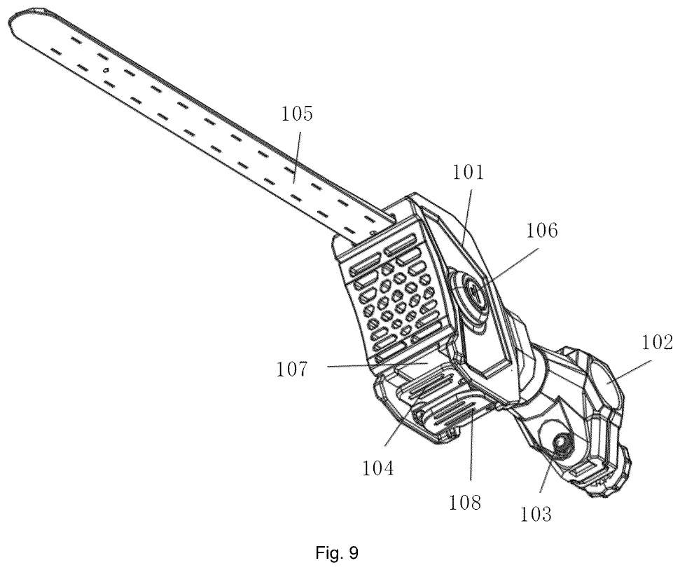

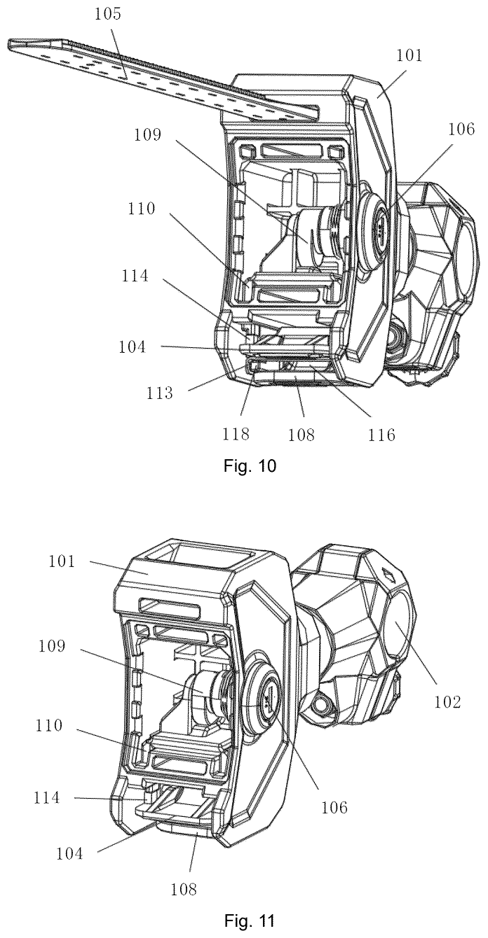

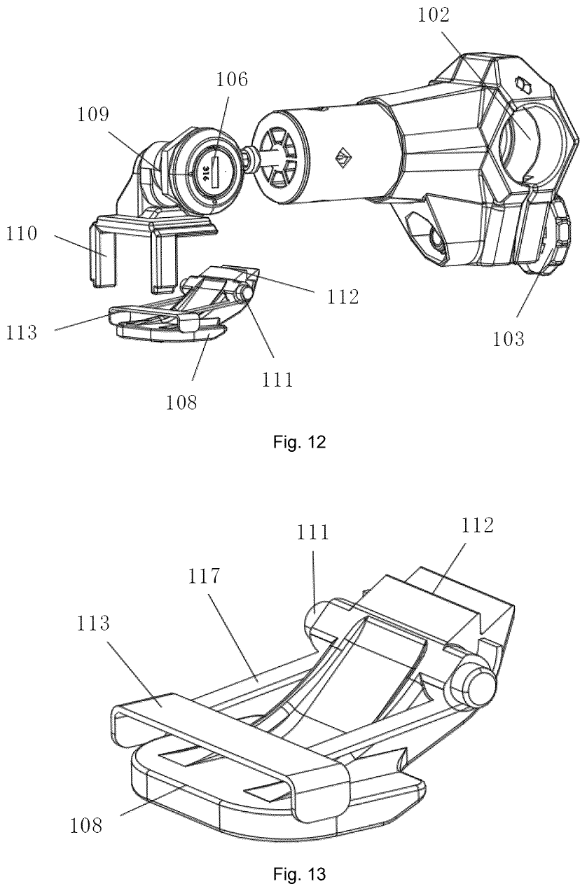

In view of this, referring to FIG. 7 to FIG. 13, the present application provides the following technical solution.

A bicycle fixing clamp includes a fixing clamp unit 101, wherein one end of the fixing clamp unit 101 is provided with a ratchet belt 105, the other end of the fixing clamp unit 101 is provided with a first clamp plate 104, a first insert slot 107 for allowing penetration and insertion of the ratchet belt 105 is arranged between the first clamp plate 104 and the fixing clamp unit 101, the first clamp plate 104 is provided with a limiting block 114, a pressing frame 110 with an adjustable height is arranged in an inner cavity of the fixing clamp unit 101, a lower end of the pressing frame 110 is pressed on an upper end of the limiting block 114, the fixing clamp unit 101 is provided with a lock catch 106, the other end of the lock catch 106 extends into the inner cavity of the fixing clamp unit 101 and is rotatably connected with a cam 109, and the cam 109 is pressed on the pressing frame 110.

An upward rotating angle of the first clamp plate 104 is limited by the pressing frame 110, and the height of the pressing frame 110 is locked through cooperating of the lock catch 106 and the cam 109, thus improving protection of a clamping state.

The first clamp plate 104 is provided with a rack having a tooth inclination direction opposite to a tooth inclination direction of the ratchet belt 105, and the ratchet belt 105 and the fixing clamp unit 101 define the inner cavity by utilizing the penetration and insertion of the first insert slot 107 by the ratchet belt 105, so as to achieve a purpose of clamping a bicycle. The ratchet belt 105 is pulled to reduce a volume of the inner cavity to achieve a fixing and clamping purpose.

A second clamp plate 108 located at a lower end of the first clamp plate 104 is arranged on the fixing clamp unit 101, the second clamp plate 108 is rotatably mounted on the fixing clamp unit 101 through an elastic torsional spring 117, a lower end of the fixing clamp unit 101 is provided with a pivot shaft 111, the second clamp plate 108 is rotatably mounted on the pivot shaft 111 through the elastic torsional spring 117, a positioning block 118 located at the lower end of the first clamp plate 104 is arranged on the fixing clamp unit 101, and a connecting frame 113 inserted in the positioning block 118 is arranged at the other end of the elastic torsional spring 117.

An elastic rotation mounting of the second clamp plate 108 is achieved through cooperating of the pivot shaft 111 and the elastic torsional spring 117, and a rotation angle of the second clamp plate 108 is limited by the positioning block 118 and the connecting frame 113.

One end of the second clamp plate 108 extends to the lower end of the first clamp plate 104, the other end of the second clamp plate 108 extends to a rear side of the rack, an end portion of the second clamp plate 108 is provided with a plurality of groups of push teeth 112, an inclination direction of the push teeth 112 is the same as the tooth inclination direction of the rack, at least two groups of push teeth 112 are provided, and a second insert slot 116 is arranged between the second clamp plate 108 and the first clamp plate 104.

A position of the lower end of the first clamp plate 104 is limited by the positioning block 118 to avoid downward deflection, and after clamping of the ratchet belt 105, the push teeth 112 are meshed with the ratchet belt 105 extending to an outer side of the first clamp plate 104 through rotation of the second clamp plate 108, and therefore, the push teeth 112 are driven by the rotation of the second clamp plate 108 to pull the ratchet belt 105 to be further stretched towards the other side of the first insert slot 107, thereby adjusting a clamping force under an available adjustment size of a tooth clearance.

Optionally, one side of the fixing clamp unit 101 may be provided with a pair of clamping hoofs 102 which are symmetrically distributed, the pair of clamping hoofs 102 define a clamping inner cavity, and an inner diameter/width of the clamping inner cavity is adjusted by the clamping hoof 102 through a tightening device 103.

Positioning and mounting of the fixing clamp unit 101 are achieved by the cooperation of the clamping hoof 102 and the tightening device 103.

Working principle: first, the fixing clamp unit 101 is positioned and mounted on a transportation frame or a vehicle frame through cooperating of the clamping hoof 102 and the tightening device 103, and then, an inner cavity is defined by the ratchet belt 105 and the fixing clamp unit 101 through penetration and insertion of the first insert slot 107 by the ratchet belt 105, so as to achieve the purpose of clamping the bicycle; the volume of the inner cavity is reduced by pulling the ratchet belt 105, so as to achieve the fixing and clamping purpose; at this point, the position of the first clamp plate 104 is limited by the pressing frame 110 and the positioning block 118, and the rack at an end portion of the first clamp plate 104 is kept meshed with teeth of the ratchet belt 105, to avoid reverse movement of the ratchet belt 105.

When the ratchet belt 105 cannot be manually pulled, through the rotation of the second clamp plate 108, the push teeth 112 are meshed with the ratchet belt 105 extending to the outer side of the first clamp plate 104, and therefore, the push teeth 112 are driven by the rotation of the second clamp plate 108 to pull the ratchet belt 105 to be further stretched towards the other side of the first insert slot 107, thereby adjusting the clamping force under the available adjustment size of the tooth clearance.

When dismounting is required, the cam 109 eccentrically rotates by releasing the lock catch 106, an upper end of the pressing frame 110 is thus unlocked, one end of the first clamp plate 104 is pressed to rotate upwards so as to release a meshed state of the rack at the end portion thereof and the ratchet belt 105, and the ratchet belt 105 can be conveniently pulled reversely, to achieve a purpose of dismounting the bicycle.

Although the present application is illustrated and described with reference to the embodiments, it will be understood to those of ordinary skill in the art that a variety of changes, modifications, replacements and variations can be made to these embodiments, without departing from the principle and spirit of the application. The scope of the present application is defined by the appended claims and their equivalents.

What is claimed is:

1. A fixing holder, comprising a cantilever tube, two ends of the cantilever tube being respectively provided with a clamping assembly, which performs clamping action by oppositely closing a convex clamp jaw and a concave clamp jaw, and a binding assembly, which performs binding and connecting action by means of a ratchet belt,
wherein the binding assembly comprises a ratchet fastening block, an inner plug is arranged at one end of the cantilever tube, a recess is formed in an end portion of the inner plug, the cantilever tube is inserted into the ratchet fastening block, and a protrusion connected with the recess in an engaged manner is arranged on the ratchet fastening block; a loop bar and a locking assembly are arranged on the ratchet fastening block, one end of the ratchet belt is rotatably mounted on the loop bar, and the other end of the ratchet belt can be fixed on the locking assembly.

2. The fixing holder according to claim 1, wherein the locking assembly comprises a lever meshed with a ratchet transmission on the ratchet belt and a key for controlling the lever to rotate relatively, and the ratchet fastening block is provided with a lock catch assembly for controlling the key to move.

3. The fixing holder according to claim 1, wherein the binding assembly forms a fixing clamp unit, one end of the fixing clamp unit is provided with the ratchet belt, the other end of the fixing clamp unit is provided with a first clamp plate, a first insert slot for allowing penetration and insertion of the ratchet belt is arranged between the first clamp plate and the fixing clamp unit, the first clamp plate is provided with a rack having a tooth inclination direction opposite to a tooth inclination direction of the ratchet belt; and a second clamp plate located at a lower end of the first clamp plate is arranged on the fixing clamp unit, the second clamp plate is rotatably mounted on the fixing clamp unit through an elastic torsional spring, one end of the second clamp plate extends to the lower end of the first clamp plate, the other end of the second clamp plate extends to a rear side of the rack, an end portion of the second clamp plate is provided with a plurality of groups of push teeth, and an inclination direction of the push teeth is the same as the tooth inclination direction of the rack.

4. The fixing holder according to claim 3, wherein the first clamp plate is provided with a limiting block, a pressing frame with an adjustable height is arranged in an inner cavity of the fixing clamp unit, and a lower end of the pressing frame is pressed on an upper end of the limiting block.

5. The fixing holder according to claim 4, wherein the fixing clamp unit is provided with a lock catch, the other end of the lock catch extends into the inner cavity of the fixing clamp unit and is rotatably connected with a cam, and the cam is pressed on the pressing frame.

6. The fixing holder according to claim 5, wherein a lower end of the fixing clamp unit is provided with a pivot shaft, and the second clamp plate is rotatably mounted on the pivot shaft through the elastic torsional spring.

7. The fixing holder according to claim 6, wherein a positioning block located at the lower end of the first clamp plate is arranged on the fixing clamp unit, and a connecting frame inserted in the positioning block is arranged at the other end of the elastic torsional spring.

8. The fixing holder according to claim 3, wherein at least two groups of push teeth are provided.

9. The fixing holder according to claim 3, wherein a second insert slot is arranged between the second clamp plate and the first clamp plate.

10. The fixing holder according to claim 1, wherein the clamping assembly comprises the convex clamp jaw and the concave clamp jaw which implement a relative elastic rotation separation through cooperating of a pivot shaft and a torsional spring, the convex clamp jaw is fixed at one end portion of the cantilever tube, a screw mandrel connected with the cantilever tube extends from the convex clamp jaw, an oblique web inclined upwards is arranged in an inner cavity of the concave clamp jaw, a T-shaped nut is in threaded connection to an end portion of the screw mandrel, and a lower end of a transverse flange at an end portion of the T-shaped nut transversely and directly faces an inclined surface of the oblique web.

11. The fixing holder according to claim 10, wherein the convex clamp jaw and the concave clamp jaw are rotatably connected through the pivot shaft, the torsional springs for driving the convex clamp jaw and the concave clamp jaw to rotate and separate relatively are arranged at two ends of the pivot shaft, a welding seat is arranged in an inner cavity of an end of the cantilever tube close to the convex clamp jaw, the screw mandrel is fixed on the welding seat, and the screw mandrel penetrates through the convex clamp jaw to extend into an inner cavity between the convex clamp jaw and the concave clamp jaw.

12. The fixing holder according to claim 11, wherein an end portion of the cantilever tube is provided with a tube plug, an end portion of the screw mandrel is provided with a mounting plate attached to the welding seat, and the tube plug and the mounting plate are fixed on the welding seat through fastening bolts.

13. The fixing holder according to claim 12, wherein a threaded through hole is arranged through the T-shaped nut, the screw mandrel rotatably penetrates through the threaded through hole by threads, and the end portion of the screw mandrel is provided with a stop ring.

14. The fixing holder according to claim 13, wherein a side of the transverse flange at the end portion of the T-shaped nut directly facing the oblique web is provided with a circular arc rounded surface.
